(19) United States
(12) Patent Application Publication
(10) Pub. No.: US 2025/0296453 A1
(43) Pub. Date: Sep. 25, 2025

(54) MOTOR VEHICLE WITH LOAD-BEARING STRUCTURE AND HIGH-VOLTAGE BATTERY

(71) Applicant: MAGNA STEYR Fahrzeugtechnik GmbH & Co KG, GRAZ (AT)

(72) Inventors: Manuel ERLACHER, Radenthein (AT); Werner SCHWARZL, Lassnitzhoehe (AT); Christian LIENHART, Seiersberg (AT); Philipp RASTL, Stainz (AT); Severin STADLER, Strobl (AT); Daniel NEUHOLD, Stattegg (AT)

(73) Assignee: MAGNA STEYR Fahrzeugtechnik GmbH & Co KG, GRAZ (AT)

(21) Appl. No.: 19/081,586

(22) Filed: Mar. 17, 2025

(30) Foreign Application Priority Data
Mar. 22, 2024 (EP) 24165530.7

(51) Int. Cl. B60L 50/64; B60K 1/04; H01M 50/24; H01M 50/271

(52) U.S. Cl. CPC B60L 50/64; B60K 1/04; H01M 50/24; H01M 50/271; B60K 2001/0438

(57) ABSTRACT

A motor vehicle that includes a support structure that includes at least two side members, a high-voltage battery that includes a battery frame having a single, unitary battery frame body that forms portions of the side members lying at least radially inwards, the battery frame operable to laterally delimit the high-voltage battery, and a plurality of battery cells arranged in the battery frame, a carrier plate forming a base of the high-voltage battery that covers an underside surface of the battery frame to enable fastening of the battery cells to the carrier plate; and a fireproof cover arranged above the battery cells to enclose the high-voltage battery with respect to an ambient environment.

### CROSS-REFERENCE TO RELATED APPLICATIONS

The present application claims priority under 35 U.S.C. § 119 to European Patent Publication No. EP 24165530.7 (filed on Mar. 22, 2024), which is hereby incorporated by reference in its complete entirety.

### TECHNICAL FIELD

The present disclosure relates to a motor vehicle comprising a support structure and comprising a high-voltage battery and a method for manufacturing such a motor vehicle.

### BACKGROUND

It is known that closed high-voltage batteries can be installed in motor vehicles, in particular as traction batteries to provide electrical energy for driving the motor vehicle. The battery then has a closed battery box or a closed battery housing that accommodates the cell modules. Such a high-voltage battery is attached to the vehicle using screws. There is usually a gap of at least a few millimetres between the battery and the vehicle structure, except at the screw points, to prevent chafing during operation (noise, corrosion, etc.), but also to enable collision-free installation. The complete battery unit must be removed from the vehicle for maintenance or repair.

Battery housings can use battery frames that consist of several individual parts and are installed next to cross members, an underride guard and a battery cover. The battery housing is attached to the underbody and can be removed. The tightness of the vehicle body is ensured by corresponding components in the floor assembly and is independent of the battery housing.

### SUMMARY

One object of the present disclosure is to provide a motor vehicle with a support structure and a high-voltage battery that has a low installation space requirement, low weight and low manufacturing costs. A further object is to provide a simple and cost-effective method for mounting the high-voltage battery in such a motor vehicle.

The objects are achieved by a motor vehicle comprising a support structure that includes at least two side members; a high-voltage battery, that includes a battery frame (formed as a single, unitary component, i.e., in one piece) laterally delimiting the high-voltage battery. A plurality of battery cells are arranged in the battery frame. Portions of the side members lying at least radially inwards are formed by the one-piece battery frame, wherein a carrier plate forms the base of the high-voltage battery covering the battery frame on its underside, wherein the battery cells are fastened to the carrier plate, wherein a fireproof cover is arranged above the battery cells and seals the high-voltage battery tightly with respect to the outside.

According to the present disclosure, a high-voltage battery uses a one-piece battery frame as the battery housing, which is not only attached to the side members, but also forms portions of the side members. In addition, the battery housing uses a carrier plate with battery cells attached to it as the base of the battery housing. On the one hand, this design reduces the installation space required for the high-voltage battery. With the same installation space, the available space in the high-voltage storage system can be increased and utilized for more battery capacity. This results in a reduction in components and lower costs and weight. In addition, a fireproof cover is positioned above the battery cells and seals the high-voltage battery with respect to the outside.

Simplified production of a motor vehicle is thus made possible. The carrier plate can be fitted with battery cells independently of the support structure and the rest of the vehicle. The fireproof cover provides safe fire protection towards the top and thus towards the vehicle occupants. The carrier plate with the battery cells forms a pre-assembled unit and is sealed with the fireproof cover. The fireproof cover can be part of the pre-assembled unit. This pre-assembled unit can be attached to a battery frame joined to the rest of the vehicle.

The fireproof cover is preferably attached to the carrier plate in a sealing manner, particularly preferably by means of a sealing screw connection. The sealing fastening can comprise a sealing element.

The core of the battery therefore comprises the carrier plate, which contains the battery cells and all electrical components, and a fireproof cover that seals the battery from above. This cover also seals the battery with respect to the outside and remains permanently installed on the carrier plate. This eliminates the need to remove a cover when installing the drive battery after delivery during vehicle production. Furthermore, a battery supplier can carry out a leak test of the fully assembled battery in-house, which would otherwise have to be done directly at the vehicle manufacturer during assembly.

Preferably, the carrier plate comprises protruding strips, preferably running in the Y-direction and/or in the X-direction, between which the battery cells are arranged. The strips can form a frame-like outer boundary of the carrier plate and/or can form pockets for holding the battery cells. The fireproof cover is preferably attached to the protruding strips of the carrier plate in a sealing manner, preferably via a sealing element.

Preferably, the carrier plate is attached to the battery frame, preferably by means of a screw connection. The carrier plate can be attached to the battery frame in a sealing manner, for example by means of a sealing element, or attached to the battery frame in a non-sealing manner.

Preferably, the underside of the carrier plate forms an underride guard plate of the vehicle. This saves even more installation space, namely in the vehicle Z-direction.

Preferably, a floor panel of the motor vehicle that closes off the interior of the motor vehicle at the bottom covers the battery frame at the top. The fireproof cover is then arranged below the floor panel and above the battery cells, i.e. between the battery cells and the floor panel.

Preferably, the battery frame forms a flange on at least one portion at the lower end of the battery frame. The battery frame is attached by the flange to another motor vehicle component, in particular to a further side member component. Particularly preferably, the battery frame forms a flange at the lower end of the battery frame on at least one side area in which a radially inner portion of the side member is formed by the battery frame. In particular, substantially the entire battery frame can form a flange at the lower end of the battery frame.

The flange is preferably arranged laterally next to the attachment of the carrier plate to the battery frame, preferably laterally next to the screw connection and/or next to an optionally arranged sealing element.

Preferably, the flange is designed to extend outwards at an angle towards the bottom. This makes it easier to subsequently insert the carrier plate, preferably with battery cells mounted on it, into the battery frame from below and attach it to the battery frame

The battery frame is preferably the last element to be inserted into the underbody unit. The lower sill flange, in particular the further side member component, therefore, preferably has an inclined position to prevent the adhesive from shearing off on the one hand and to enable the component to be centred on the other.

Seat cross members are preferably attached to the cover of the high-voltage battery.

Preferably, the one-piece battery frame forms at least radially inner portions of at least one cross member, preferably two cross members. Preferably, the portions of cross members form the front and rear portions of the battery frame in the motor vehicle and the portions of side members form the left and right portions of the battery frame in the motor vehicle.

Preferably, the battery cells are inserted directly into the carrier plate, preferably as individual battery cells. It is particularly preferable for the carrier plate to form pockets that are open at the top, into which the battery cells are inserted.

A method for manufacturing a motor vehicle as described above can provide for the battery cells to be attached to the carrier plate and then for the fireproof cover to be positioned above the battery cells and attached to the carrier plate in a sealing manner, in particular screwed on. This pre-assembled installation unit can optionally be tested for leaks and can then be delivered to the customer.

Independently of the mounting of the battery cells and the cover on the carrier plate, and thus independently of the pre-assembly of this installation unit, the battery frame is mounted on another motor vehicle component, in particular on a further side member component. The carrier plate with the attached battery cells and the attached fireproof cover is then inserted from below into the battery frame already mounted on another motor vehicle component, in particular on a further side member component, and attached to this battery frame.

### DRAWINGS

The present disclosure is described hereinbelow by way of example with reference to the drawings.

FIG. 1 is a partial sectional view of a motor vehicle according to the present disclosure, cut in the vehicle X-direction.

FIG. 2 is a partial sectional view of a motor vehicle according to the present disclosure, cut in the vehicle Y-direction.

FIG. 3 is a partial sectional view of an alternative motor vehicle according to the present disclosure, cut in the vehicle Y-direction.

### DESCRIPTION

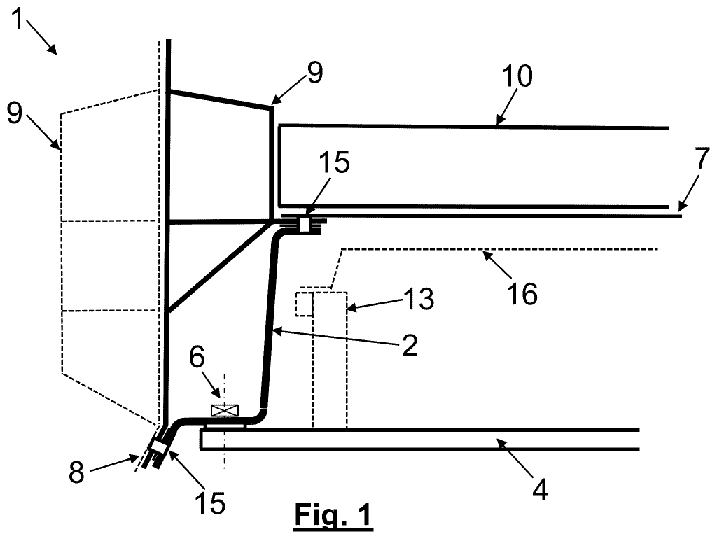

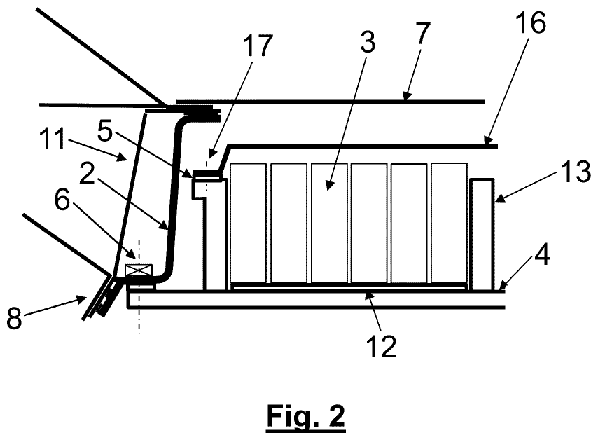

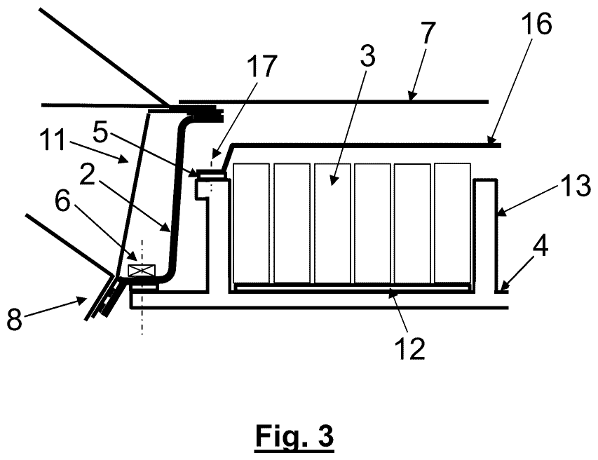

In FIG. 1, a motor vehicle according to the present disclosure is shown in a detail near a side member 1, i.e. a sill, formed from the components of battery frame 2 and further side member components 9, wherein the sectional view is cut in the vehicle X-direction, i.e., in a plane that is normal to the X-axis of the motor vehicle. FIG. 2 and FIG. 3 show alternative versions of a motor vehicle according to the present disclosure, cut in the vehicle Y-direction, i.e., in a plane that is normal to the Y-axis of the motor vehicle.

As shown in FIG. 1, the motor vehicle comprises a support structure having at least two side members 1, and a high-voltage battery having an annular battery frame 2 laterally delimiting the high-voltage battery. The battery frame 2 forms a single, unitary component (i.e., one piece). The one-piece battery frame 2 forms radially inner portions of the side member 1, i.e. the sill, namely inner and lower portions of the side member 1. Inner upper portions and outer portions of the sill are formed by further side member components 9.

The battery frame 2 forms the lateral delimitation of the battery housing of the high-voltage battery. The battery frame 2 can be made of steel. A carrier plate 4 forms the base of the high-voltage battery covering the underside of the battery frame 2 and thus the base of the battery housing. The battery cells 3 are attached to the carrier plate 4, preferably as individual cells, as shown in FIG. 2 and FIG. 3. The battery cells 3 can be mounted upright on the carrier plate 4. A cooling plate 12 can be arranged between the carrier plate 4 and the battery cells 3. The battery cells 3 are arranged in the battery frame 2. The underside of the carrier plate 4 forms an underride guard plate of the motor vehicle.

A floor panel 7 of the motor vehicle that closes off the interior of the motor vehicle at the bottom forms a cover of the high-voltage battery that covers the top of the battery frame 2. Seat cross members 10 are attached to the cover of the high-voltage battery, i.e. to the floor panel 7.

As can be seen in the upper region of FIG. 1, the battery frame 2, the floor panel 7, and preferably also a further side member component 9, are joined together by means of self-piercing riveting (SPR) and adhesive 15.

A fireproof cover 16 is arranged between the battery cells 3 and the cover, i.e. the base plate 7, as a plate-shaped element. The position of the fireproof cover 16 and a strip 13 of the carrier plate 4 are merely indicated in FIG. 1 and can be better recognized in FIGS. 2 and 3. Together with the carrier plate 4, the cover 16 tightly encloses the battery cells 3. The fireproof cover 16 is attached in a sealing manner to the carrier plate 4, in particular to the strips 13 of the carrier plate 4, by means of a screw connection 17 of the fireproof cover and via a sealing element 5.

The carrier plate 4 can thus have protruding strips 13, preferably running in the Y direction, which delimit the battery cells 3 on the outside and/or between which the battery cells 3 are arranged. The carrier plate 4 can be designed in several parts so that, for example, the strips 13 are joined to a base plate, preferably welded, as shown in FIG. 2. The carrier plate 4 can be formed in one piece, as shown in FIG. 3, and can preferably be formed by a cast component.

The carrier plate 4 is attached to the battery frame 2 in a sealing or non-sealing manner, for example by means of a sealing element, and preferably by means of a screw connection 6. The screw connection 6 of the carrier plate 4 to the housing, namely to the battery frame 2, can be removed.

A sealing element can be an EPDM seal (ethylene propylene diene monomer rubber), for example.

The battery frame 2 forms a flange 8 at the lower end of the battery frame, wherein the battery frame is fastened by the flange 8 to another motor vehicle component, namely to a further side member component 9, preferably by means of adhesive 15 and self-piercing riveting. The battery frame 2 can also be attached outside the flange 8, in particular at the upper end of the battery frame 2, to another motor vehicle component, preferably to a further side member component 9, for example by means of adhesive 15 and self-piercing riveting, as shown in FIG. 1.

The flange 8 is arranged laterally next to the attachment of the carrier plate 4 to the battery frame 2, namely laterally next to the sealing element 5 and the screw connection 6.

The flange 8 of the battery frame 2 and also of the other side member component 9 is inclined outwards towards the bottom. The flange is preferably inclined by about 20 to 40 degrees, preferably by about 30 degrees. This makes it easier to insert the carrier plate 4 into the battery frame 2 from below, as well as to insert the battery frame 2 into the additional side member component 9.

As shown in FIGS. 2 and 3, the one-piece battery frame 2 can form radially inner portions of cross members 11, in particular, a cross member 11 located at the front and a cross member 11 located at the rear of the battery frame 2.

In a method for manufacturing a motor vehicle as shown in FIGS. 1 to 3, the battery cells 3 are attached to the carrier plate 4, then the fireproof cover 16 is arranged above the battery cells 3 and attached to the carrier plate 4 in a sealing manner. Independently of this, for example at a different location, the battery frame 2 is mounted on another motor vehicle component, in particular on a further side member component 9. The carrier plate 4 with the attached battery cells 3 and the fireproof cover 16 is then attached from below to the battery frame 2 already mounted on another motor vehicle component, in particular, on a further side member component 9.

The present disclosure thus describes the integration of a high-voltage storage system, made from a one-piece circumferential ring, namely battery frame 2, which is integrated from below into a base assembly and is closed from below with a battery module, which in turn comprises a carrier plate 4, which is fitted with battery cells 3 and is closed with a cover 16.

In this design, a one-piece circumferential ring made of steel, battery frame 2, is permanently joined into the body shell from below. On the one hand, the one-piece ring replaces the sill at the bottom inside and at the same time separates the battery housing from the sill.

This ring is the last element to be inserted into the underbody unit, which makes it necessary to incline the lower sill flange, flange 8, in order to prevent the adhesive 15 from shearing off and to allow the component to be centred.

The resulting cavity serves as an installation space for a drive battery and is sealed when the battery unit is installed.

The battery comprises a carrier plate 4, which contains the battery cells 3 and all electrical components, and a fireproof cover 16, which closes the battery from above.

This cover also seals the battery from the outside and remains permanently installed on the carrier plate 4. This eliminates the need to remove a battery cover when installing the drive battery.

Furthermore, the battery supplier can carry out the leak test of the fully assembled battery in-house, which would otherwise have to be done by the vehicle manufacturer directly during assembly.

The carrier plate 4 for the battery cells 3 can consist of a multi-part welded construction, and in one embodiment can also be manufactured as a one-piece cast component.

The carrier plate 4 forms pockets at the top in which the battery cells 3 can be inserted directly without having to be combined as modules beforehand.

Pre-assembly of the drive battery is preferably carried out in a disassembled state at a supplier, and the battery is delivered secured with a high-voltage cover. First, the cooling plates 12 are inserted into the carrier plate 4, then the cells 3 are inserted into the carrier plate 4 from above and electrically connected to each other. Finally, the carrier plate 4 and the cover 16 are screwed together using screw connection 17. The battery is then checked for leaks and can then be delivered to the customer.

A major advantage of this arrangement is the elimination of one large component (battery cover), as well as the integration of several components and the associated cost and weight savings.

With this design, a modular construction of the battery cells 3 can be easily replaced by a cell-to-pack arrangement, whereby a higher energy density can be realized in the same installation space.

The Z-dimension chain also becomes smaller due to the missing air gap between the base plate and the battery housing.

### LIST OF REFERENCE SYMBOLS

1 side member
2 battery frame
3 battery cells
4 carrier plate
5 sealing element
6 screw connection
7 base plate
8 flange
9 further side member component
10 seat cross member
11 cross member
12 cooling plate
13 strip
15 self-piercing rivets and adhesives
16 fireproof cover
17 screw connection of the fireproof cover

What is claimed is:

1. A motor vehicle, comprising:
a support structure that includes at least two side members;
a high-voltage battery that includes a battery frame having a single, unitary battery frame body that forms portions of the side members lying at least radially inwards, the battery frame operable to laterally delimit the high-voltage battery, and a plurality of battery cells arranged in the battery frame;
a carrier plate forming a base of the high-voltage battery that covers an underside surface of the battery frame to enable fastening of the battery cells to the carrier plate; and
a fireproof cover arranged above the battery cells to enclose the high-voltage battery with respect to an ambient environment.

2. The motor vehicle of claim 1, wherein the fireproof cover is sealingly attached to the carrier plate via a sealing screw connection and/or a sealing element.

3. The motor vehicle of claim 2, wherein the carrier plate comprises a plurality of strips oriented vertically and between which the battery cells are arranged.

4. The motor vehicle of claim 3, wherein the fireproof cover is sealingly fastened to the projecting strips.

5. The motor vehicle of claim 1, wherein the carrier plate is mechanically fastened to the battery frame via a screw connection.

6. The motor vehicle of claim 1, further comprising an underride guard plate defined by an underside surface of the carrier plate.

7. The motor vehicle of claim 1, further comprising a floor panel which covers an upper region of the battery frame.

8. The motor vehicle of claim 7, wherein the floor panel closes off a bottom region of an interior compartment of the motor vehicle.

9. The motor vehicle of claim 8, further comprising seat cross members attached to the floor panel.

10. The motor vehicle of claim 8, wherein the fireproof cover is arranged between the battery cells and the floor panel.

11. The motor vehicle of claim 1, wherein the battery frame forms a flange on at least one portion at a lower end thereof.

12. The motor vehicle of claim 11, wherein the flange is operable to fasten the battery frame to another motor vehicle component.

13. The motor vehicle of claim 11, wherein the flange is arranged laterally next to an attachment of the carrier plate to the battery frame.

14. The motor vehicle of claim 11, wherein the flange is oriented obliquely outwards at a bottom thereof.

15. The motor vehicle of claim 1, further comprising at least one cross member defined by the battery frame body at a front region thereof.

16. The motor vehicle of claim 15, wherein the battery frame body forms at least radially inner portions of the at least one cross member.

17. The motor vehicle of claim 1, wherein the carrier plate defines pockets into which the battery cells are received directly therein.

18. The motor vehicle of claim 1, wherein the battery cells are individually received in the pockets.

19. A motor vehicle, comprising:
a high-voltage battery that includes a battery frame having a single, unitary battery frame body that forms portions of sill members, the battery frame operable to laterally delimit the high-voltage battery, and a plurality of battery cells arranged in the battery frame;
a carrier plate forming a base of the high-voltage battery that covers an underside surface of the battery frame to enable fastening of the battery cells to the carrier plate; and
a fireproof cover arranged above the battery cells to enclose the high-voltage battery with respect to an ambient environment.

20. A method for manufacturing a motor vehicle of claim 1, the method comprising:
providing a high-voltage battery that includes a battery frame having a single, unitary battery frame body that forms portions of vehicle side members to laterally delimit the high-voltage battery;
fastening a plurality of battery cells to a carrier plate that forms a base of the high-voltage battery;
sealingly fastening a fireproof cover to the carrier plate for orientation above the battery cells to enclose the high-voltage battery with respect to an ambient environment;
mounting the battery frame to a motor vehicle component; and
attaching the carrier plate with the battery cells and the fastened fireproof cover from below to the battery frame.
